(19) United States
(12) Patent Application Publication
(10) Pub. No.: US 2024/0227800 A1
(43) Pub. Date: Jul. 11, 2024

(54) Method for Operating a Driver Assistance System for Longitudinal Control of a Vehicle With Proactive Suggestion for Functional Use, Driver Assistance System and Vehicle

(71) Applicant: Bayerische Motoren Werke Aktiengesellschaft, Muenchen (DE)

(72) Inventors: Wolfgang SPIESSL, Freising (DE); Walter KAGERER, Muenchen (DE); Andreas LECHNER, Muenchen (DE)

(21) Appl. No.: 18/558,777

(22) PCT Filed: Apr. 29, 2022
(86) PCT No.: PCT/EP2022/061603

§ 371 Date: Nov. 3, 2023

(30) Foreign Application Priority Data
May 4, 2021 (DE) 10 2021 111 546.9

(51) Int. Cl. B60W 30/14; B60W 50/10; B60W 50/14

(52) U.S. Cl. CPC B60W 30/146; B60W 50/10; B60W 50/14; B60W 2420/403; B60W 2520/10; B60W 2555/60; B60W 2720/10

(57) ABSTRACT

Systems, methods, and apparatuses for operating a driver assistance system of a vehicle are provided. A permissible maximum speed for a road on which the vehicle is currently moving is captured. A first operating action that is carried out by a driver of the vehicle to activate longitudinal control of the vehicle is captured. The longitudinal control is carried out. A target speed of the vehicle during the longitudinal control corresponds to the permissible maximum speed. A second operating action by the driver that is carried out after the first operating action is analyzed. A notification is output to the driver if it is recognized, based on analysis of the second operating action, that the driver would adapt the target speed using the second operating action.

### BACKGROUND AND SUMMARY

The present subject matter relates to a method for operating a driver assistance system of a vehicle. The present subject matter also relates to a driver assistance system for a vehicle. Finally, the present subject matter relates to a vehicle having such a driver assistance system.

Different driver assistance systems which can assist a driver or user with the driving of the vehicle are known from the prior art. For example, driver assistance systems which indicate the currently permissible maximum speed to the driver are known. For this purpose, traffic signs can be detected using a camera, for example. This function can be expanded with speed control or longitudinal control. If, for example, the driver has chosen to accept the speed limit during active speed control, the driver assistance system automatically adapts the speed to the signage or the currently permissible maximum speed.

In addition, speed control with distance control is known from the prior art. This function can also be referred to as adaptive cruise control (ACC). The function automatically measures the safety distance from a vehicle traveling in front and adapts the driving speed accordingly. In the case of this speed control as well, the currently permissible maximum speed can be considered or the speed limit can be accepted. In addition, it is possible for the driver to adapt the target speed, which is used for the speed control or longitudinal control, using an appropriate operating input.

Overall, different functions are made available or offered to the driver in connection with the longitudinal control or speed control. This may result in the driver being confused and/or not being able to operate the functions as desired.

Therefore, the object of the present subject matter is to show a solution for how a driver can be easily and reliably assisted when using a driver assistance system for the longitudinal control of a vehicle of the type mentioned at the outset. In addition, the intention is to provide a vehicle having such an assistance system.

A method according to the present subject matter is used to operate a driver assistance system of a vehicle. The method comprises capturing a permissible maximum speed for the road on which the vehicle is currently moving or currently situated. In addition, the method comprises capturing a first operating action that is carried out by a driver of the vehicle for the purpose of activating longitudinal control of the vehicle. The method also comprises carrying out the longitudinal control, wherein a target speed of the vehicle during the longitudinal control corresponds to the permissible maximum speed. In addition, the method comprises analyzing a second operating action by the driver that is carried out after the first operating action. Furthermore, the method comprises outputting a notification to the driver if it is recognized, on the basis of the analysis of the second operating action, that the driver would like or wishes to adapt the target speed by means of the second operating action.

The longitudinal control of the vehicle is intended to be enabled with the aid of the driver assistance system. In this case, the speed of the vehicle or the longitudinal speed of the vehicle can be controlled to a target speed or desired speed. Provision may be additionally made for the distance from a vehicle traveling in front to be measured during longitudinal control and for the current speed of the vehicle to be adapted to the distance during longitudinal control. Provision is also made for the target speed of the vehicle to correspond to the permissible maximum speed during longitudinal control. The permissible maximum speed or the permitted maximum speed relates to the road on which the vehicle is also currently moving. The permissible maximum speed describes, in particular, the maximum speed currently applicable to the vehicle. The permissible maximum speed can also be referred to as a speed limit. In order to be able to determine the permissible maximum speed, a camera of the driver assistance system can be used to capture corresponding traffic signs, information signs, displays of traffic management systems, sign gantries or the like. In addition, digital map data can be used to determine the permissible maximum speed.

In order to activate the longitudinal control of the vehicle, the driver or user of the vehicle can carry out the first operating action. During this first operating action, the driver can actuate a corresponding operating button, for example. This operating button may preferably be arranged on the steering wheel of the vehicle. As soon as the driver carries out the first operating action or pushes the operating button, the longitudinal control of the vehicle is activated, wherein the target speed corresponds to the current permissible maximum speed or the speed limit during longitudinal control.

Upon activation of the longitudinal control of the vehicle, the situation may arise in which the driver actually did not want to activate the longitudinal control at all with the acceptance of the speed limit. This may be the case, for example, if the current speed of the vehicle differs from the permissible maximum speed. In this case, the driver can assume, for example, that the target speed corresponds to the current speed of the vehicle and not to the permissible maximum speed upon activation of the longitudinal control. In addition, the situation may arise in which the driver has not known the function of the longitudinal control with the acceptance of the speed limit before carrying out the first operating action.

Therefore, the present subject matter provides for a second operating action by the driver, which is carried out after the first operating action, to be analyzed. In this case, the second operating action may comprise a plurality of individual operating steps. Such an operating step may be, for example, the actuation of an operating element, the actuation of an operating button, the performance of a voice input, the performance of an operating gesture, the actuation of an accelerator pedal, the actuation of a brake pedal or the like. If the second operating action comprises a plurality of individual operating steps, these may be carried out, in particular, within a predetermined period of time after the first operating action.

In addition, a notification is output to the driver if it is recognized, on the basis of the analysis of the second operating action, that the driver would like to adapt the target speed by means of the second operating action. A type of pattern recognition is therefore intended to be carried out in order to analyze the user behavior or the second operating action. The analysis of the second operating action is intended to be used to recognize that the driver makes or would like to make corrections subsequently or after activation of the longitudinal control. In particular, the intention is to recognize that the driver did not want to activate the longitudinal control at all with the acceptance of the speed limit or the permissible maximum speed or did not want to make this adjustment at all. If this is recognized on the basis of the analysis of the second operating action, the notification can be output to the driver. This notification can be used to assist the driver when using the driver assistance system with the longitudinal control.

The second operating action is preferably compared with a reference operating action for adapting the target speed, and the notification is output if the target speed is adapted by way of a smaller number of operating steps and/or within a shorter period of time by means of the reference operating action in comparison with the second operating action. As previously explained, the second operating action by the driver is analyzed after activating the longitudinal control with the acceptance of the permissible maximum speed. In this case, the intention is to recognize whether there is an easier possible way of making the adjustment or adaptation desired by the driver.

It is assumed that the driver would like to adapt the target speed for the longitudinal control by means of the second operating action. In this case, the predetermined reference operating action is taken into account, in particular. This reference operating action describes that operating action or the at least one operating step which is actually provided for the purpose of adapting the target speed. This reference operating action can be specified, for example, by the manufacturer of the vehicle or of the driver assistance system. If the second operating action now differs from this reference operating action or if the second operating action uses a greater number of operating steps and/or takes a longer period of time, the notification is output to the driver. In other words, the notification is output to the driver only when the driver or the user can also be assisted.

In this case, provision is made, in particular, for the notification which is output to the driver to describe the reference operating action. Therefore, it is possible to indicate to the driver, for example, how the driver can adapt the target speed for the longitudinal control in a simple manner or within a short period of time. The driver can therefore be provided with an instruction of how the driver can adapt the target speed. Alternatively or additionally, provision may be made for the function or functionality linked to the first operating action to be explained to the driver in the notification. It is therefore possible to indicate to the driver which function is activated during the first operating action or the actuation of the operating button. In this manner, a driver unfamiliar with the longitudinal control function, for example, can be provided with an instruction for correctly using the function.

In a further example, the notification is output if the second operating action is carried out within a predetermined period of time after the first operating action and/or if the second operating action is carried out once again after the first operating action. The intention is therefore to identify, in particular, a temporal relationship between the first operating action or the actuation of the operating button and the subsequent, second operating action or the adjustment of the target speed. In this case, the notification can be output only if the second operating action is carried out within the predetermined period of time, which may be 10 seconds for example, after the first operating action.

Alternatively or additionally, it is possible to check whether the second operating action is carried out repeatedly, for example three times in succession, after respectively carrying out the first operating action. In this case too, the notification can be output only when the second operating action is carried out once again after the first operating action. This makes it possible to recognize that there is obvious incorrect use of the operating button assigned to the first operating action. Therefore, the notification can also be output only when the driver or user actually requires assistance.

In a further example, adaptation of the target speed by a predetermined speed value is suggested to the driver when outputting the notification. If it is recognized that the driver would like to adapt the target speed for the longitudinal control during the second operating action, appropriate adaptation of the target speed can be suggested to the driver when outputting the notification. For example, the predetermined speed value which is added to the captured permissible maximum speed or is subtracted from the captured permissible maximum speed can be suggested to the driver. In other words, an appropriate speed offset can be suggested to the driver, for example, in order to be able to adapt the target speed. In this case, the predetermined speed value may have a fixed value, for example 5 km/h. Provision may also be made for the speed value to be determined on the basis of previous adjustments by the driver or a speed offset stored by the driver.

In a further example, adaptation or the activation of the longitudinal control linked to the first operating action is suggested to the driver when outputting the notification. With the output of the notification, it can be suggested to the driver to deactivate the function for accepting the current maximum speed or the speed limit. Alternatively, it can be suggested to activate the automatic acceptance of the captured maximum speed or the speed limit. In addition, provision may be made for adaptation of the target speed to be suggested to the driver. In this case, the driver can input, for example, how the target speed is intended to be selected. For example, the driver can indicate that the target speed corresponds to the current speed of the vehicle when actuating the operating button or when carrying out the first operating action. The target speed for the longitudinal control of the vehicle can therefore be individually specified by the driver.

In a further example, it is recognized that the driver would like to adapt the target speed by means of the second operating action if the target speed is corrected during the second operating action. For example, it can be recognized that the target speed is manually increased or decreased several times in succession or always by the same value, for example 5 km/h, after the acceptance of the speed limit. Furthermore, it can be recognized that the driver would like to adapt the target speed by means of the second operating action if an accelerator pedal is actuated by the driver during the second operating action. It can therefore be recognized that the driver overrides the longitudinal control manually or by actuating the accelerator pedal. In addition, it is recognized that the driver would like to adapt the target speed by means of the second operating action if an automatic change in the target speed, if the permissible maximum speed for the road changes, is confirmed during the second operating action. Provision may be made for adaptation of the target speed for the longitudinal control to the speed limit to also be suggested if the speed limit changes. If any suggestion to accept the speed limit is confirmed by the driver here, it can be assumed that the driver would like to adapt the target speed. In addition, it can be recognized that the driver would like to adapt the target speed by means of the second operating action if the changed target speed is adapted during the second operating action when automatically changing the target speed if the permissible maximum speed for the road changes. In other words, it can therefore be recognized that, after the automatic acceptance of the speed limit, there is very often a reset to the previous value. This pattern recognition during the second operating action makes it possible to reliably recognize that the driver would like to adapt the target speed for the longitudinal control.

It is also advantageous if a current speed of the vehicle before the first operating action is determined and it has been recognized that the driver would like to adapt the target speed by means of the second operating action if the target speed is adapted to the current speed during the second operating action. In other words, the current speed of the vehicle before actuating the operating button or before carrying out the first operating action can be determined. If it is then recognized that, after accepting the current maximum speed, the target speed is manually corrected to be close to the actual speed or the current speed of the vehicle before carrying out the first operating action, it is assumed that the driver would like to adapt the target speed. It can be assumed here that the driver accepts that the target speed for the longitudinal control corresponds to the current speed of the vehicle and not to the speed limit.

A driver assistance system according to the present subject matter for a vehicle is configured to carry out a method according to the present subject matter and the advantageous configurations thereof. The driver assistance system may be configured to capture the permissible maximum speed for the road on which the vehicle is currently moving. For this purpose, the driver assistance system may have a camera or another environmental sensor which can be used to detect traffic signs or the like in the environment. Furthermore, the driver assistance system may have an environmental sensor, for example a radar sensor, which can be used to determine the distance from a vehicle traveling in front.

In addition, the driver assistance system may be configured to capture a first operating action for activating longitudinal control of the vehicle. For this purpose, the driver assistance system may have a first operating element. In addition, the driver assistance system may be configured to carry out longitudinal control, wherein a target speed of the vehicle during longitudinal control corresponds to the permissible maximum speed. In addition, the driver assistance system may have a computing device which is configured to analyze a second operating action by the driver that is carried out after the first operating action. For this purpose, it is possible to capture the operating input on at least one second operating element of the driver assistance system. In addition, the driver assistance system may have an output device which can be used to output a notification to the driver if it is recognized, on the basis of the analysis of the second operating action, that the driver would like to adapt the target speed by means of the second operating action.

A vehicle according to the present subject matter comprises a driver assistance system according to the present subject matter. The vehicle is in the form of an automobile, in particular.

The preferred examples and their advantages presented with respect to the method according to the present subject matter accordingly apply to the driver assistance system according to the present subject matter and to the vehicle according to the present subject matter.

Further features of the present subject matter emerge from the claims, the figures and the description of the figures. The features and combinations of features mentioned above in the description and the features and combinations of features mentioned in the description of the figures below and/or shown in the figures alone can be used not only in the respectively stated combination but also in other combinations or alone without departing from the scope of the present subject matter.

### BRIEF DESCRIPTION OF THE DRAWINGS

FIG. 1 shows a schematic illustration of a vehicle having a driver assistance system for carrying out longitudinal control; and

FIG. 2 shows the vehicle according to FIG. 1 in an example traffic situation.

### DETAILED DESCRIPTION OF THE DRAWINGS

In the figures, identical or functionally identical elements are provided with the same reference signs.

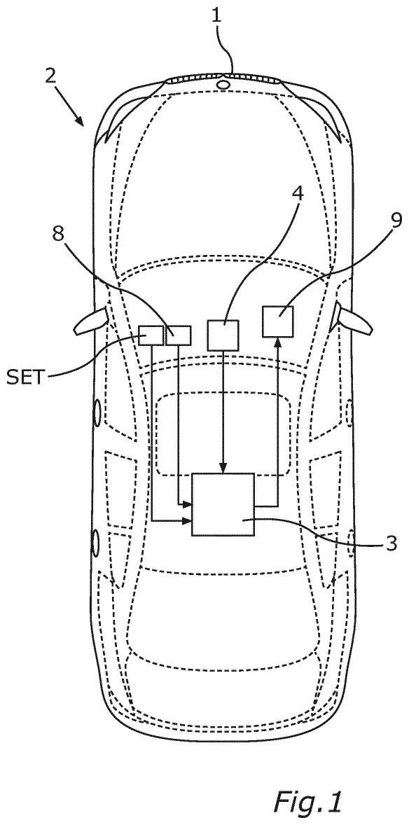

FIG. 1 shows a schematic illustration of a vehicle 1 which is in the form of an automobile in the present case. The vehicle 1 comprises a driver assistance system 2 which can be used to carry out longitudinal control of the vehicle 1. The driver assistance system 2 can be used to control the longitudinal speed of the vehicle to a target speed. Provision may also be made for automatic cruise control (ACC) to be implemented by means of the driver assistance system 2 by taking the target speed into account.

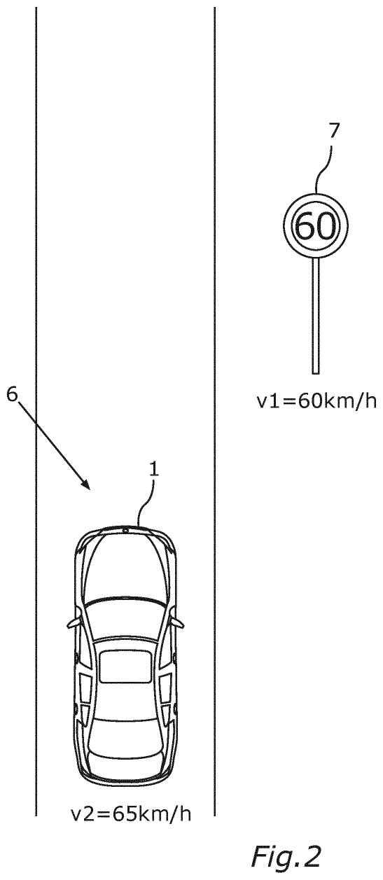

The driver assistance system 2 comprises a camera 4 which can be used to capture information relating to a permissible maximum speed v1 on a road 6 on which the vehicle 1 is currently situated. For example, the camera 4 can be used to capture a traffic sign 7 which describes the permissible maximum speed v1 (see FIG. 2). The driver assistance system 2 also comprises a computing device 3 which can be formed, for example, by at least one electronic control unit of the vehicle 1. This computing device 3 is connected to the camera 4 for the purpose of transmitting data and can therefore accordingly evaluate image data provided using the camera 4.

The driver assistance system 2 also comprises a first operating button SET, the actuation of which makes it possible for the driver to carry out a first operating action. In addition, the longitudinal control of the vehicle 1 with acceptance of the current permissible maximum speed v1 can be activated by actuating the operating button SET or by means of the first operating action. Furthermore, the driver assistance system 2 or the computing device 3 is configured to analyze a second operating action that is carried out by the driver after actuating the operating button SET. In the present case, a second operating button 8, on which the driver can carry out the second operating action, is shown by way of example. In principle, the second operating action may comprise a plurality of operating steps or the actuation of a plurality of operating buttons, the performance of voice commands, operating gestures or the like.

The driver assistance system 2 also comprises an output device 9 which can be used to output a notification to the driver. This notification can be output optically, acoustically and/or haptically. In this case, provision is made for the notification to be output if it is recognized, on the basis of the analysis of the second operating action, that the driver would like to adapt the target speed by means of the second operating action.

FIG. 2 shows, by way of example, a traffic situation of the vehicle 1 according to FIG. 1 on a road 6. A permissible maximum speed v1 of 60 km/h is assigned to this road 6. This can be detected by means of the camera 4 of the driver assistance system 2 on the basis of the traffic sign 7. In the present case, it is assumed that the vehicle 1 is moving at a current speed v2 of 65 km/h. It is also assumed that the driver actuates the first operating button SET in the expectation that the current speed v2 of 65 km/h will be accepted into the longitudinal control system by virtue of this first operating action. In fact, the driver assistance system 2 is activated with the currently applicable speed limit v1 of 60 km/h by virtue of the first operating action or the actuation of the operating button SET.

Furthermore, after activating the longitudinal control, it is recognized that the driver would like to increase the set target speed from 60 km/h to 65 km/h by means of the second operating action. If this is repeatedly recognized, for example, the notification can be output to the driver by means of the output device 9. Alternatively, the user can be offered a further function for adapting the set speed, for example 5 km/h above the speed limit. Alternatively, it can be suggested to deactivate the function for accepting the current maximum speed.

In principle, incorrect use of the longitudinal control of the vehicle 1 can be identified on the basis of the observation of the user behavior or the second operating action. In this case, it is possible to recognize the manual correction of the set target speed, for example in a particular period of time after the actuation of the first operating button SET. For example, it is possible to recognize that the target speed is adjusted in the direction of the current speed v2 of the vehicle 1. Alternatively, provision may be made for the target speed to always be manually increased or decreased by the same speed value after acceptance. It may also be the case that the accelerator pedal is always actuated in order to override the longitudinal control after acceptance. In addition, the driver's desire to adapt the target speed can be recognized from the fact that, when changing the target speed if the permissible maximum speed changes, this suggestion is confirmed or very often there is a reset to the previous value.

Overall, it is therefore possible to identify situations in which the target speed set by actuating the first operating button SET does not correspond to the target speed desired by the driver. Analyzing the second operating action makes it possible to recognize, in particular, that the driver did not want at all to make the adjustment made by actuating the first operating button SET. Furthermore, it is possible to check whether, in comparison with the second operating action, there is a simpler possible way of adapting the target speed. If this is the case, the notification can be output to the driver. The driver or user can therefore be provided with suggestions for correctly operating and productively using the longitudinal control function or the first operating button SET.

1.-10. (canceled)

11. A method for operating a driver assistance system of a vehicle, comprising:
capturing a permissible maximum speed for a road on which the vehicle is currently moving,
capturing a first operating action that is carried out by a driver of the vehicle to activate longitudinal control of the vehicle,
carrying out the longitudinal control, wherein
a target speed of the vehicle during the longitudinal control corresponds to the permissible maximum speed,
analyzing a second operating action by the driver that is carried out after the first operating action, and
outputting a notification to the driver if it is recognized, based on analysis of the second operating action, that the driver would adapt the target speed using the second operating action.

12. The method according to claim 11, further comprising:
comparing the second operating action with a reference operating action for adapting the target speed, and
outputting the notification if the target speed is adapted by way of a smaller number of operating steps and/or within a shorter period of time using the reference operating action in comparison with the second operating action.

13. The method according to claim 12, wherein the notification which is output to the driver describes the reference operating action.

14. The method according to claim 11, further comprising:
outputting the notification
if the second operating action is carried out within a predetermined period of time after the first operating action and/or
if the second operating action is carried out once again after the first operating action.

15. The method according to claim 11, further comprising:
suggesting adaptation of the target speed by a predetermined speed value to the driver when outputting the notification.

16. The method according to claim 11, further comprising:
suggesting adaptation or deactivation of the longitudinal control linked to the first operating action to the driver when outputting the notification.

17. The method according to claim 11, further comprising:
recognizing the driver would like to adapt the target speed using the second operating action if:
the target speed is corrected during the second operating action,
an accelerator pedal is actuated by the driver during the second operating action,
an automatic change in the target speed, if the permissible maximum speed changes, is confirmed during the second operating action, and/or
the changed target speed is adapted during the second operating action when automatically changing the target speed if the permissible maximum speed changes.

18. The method according to claim 11, further comprising:
determining a current speed of the vehicle before the first operating action; and
recognizing the driver would adapt the target speed using the second operating action if the target speed is adapted to the current speed during the second operating action.

19. A driver assistance system for a vehicle, wherein the driver assistance system is configured to carry out the method according to claim 11.

20. An automobile, comprising:
the drive assistance system according to claim 19.
